(19) United States
(12) Patent Application Publication
(10) Pub. No.: US 2005/0251570 A1
(43) Pub. Date: Nov. 10, 2005

(54) Intrusion detection system

(76) Inventors: John Heasman, Crawley (GB); Steve Movle, New Hinksev (GB)

Correspondence Address: OPPEDAHL AND LARSON LLP, P O BOX 5068, DILLON, CO, 80435-5068, US

(21) Appl. No.: 10/511,775

(22) PCT Filed: Apr. 2, 2003
(86) PCT No.: PCT/GB03/01466

§ 371 Date: May 16, 2005

(30) Foreign Application Priority Data
Apr. 18, 2002 (GB) 0208916.7

(51) Int. Cl. G06F 15/173

(52) U.S. Cl. 709/224; 709/225

(57) ABSTRACT

An intrusion detection system for detection of intrusion or attempted intrusion by an unauthorised party or entity to a computer system or network, the intrusion detection system comprising means for monitoring the activity relative to the computer system or network, means for receiving and storing one or more general rules, each of the general rules being representative of characteristics associated with a plurality of specific instances of intrusion or attempted intrusion, and matching means for receiving data relating to activity relative to said computer system or network from the monitoring means and for comparing, in a semantic manner, sets of actions forming the activity against the one or more general rules to identify an intrusion or attempted intrusion. Inductive logic techniques are proposed for suggesting new intrusion detection rules for inclusion into the system, based on examples of sinister traffic.

This invention relates to an intrusion detection system (IDS), i.e. a system for automated identification of breaches in security policy of a computer system or network.

Large amounts of data are transmitted on a daily basis through computer networks, particularly via the Internet. It will be appreciated that the Internet is intended to provide efficient transport of data from a first location to one or more endpoints, and little consideration was given historically to the security of nodes on the network. Therefore, unauthorised users or hackers have unfortunately gained relatively easy access to networks, as well as nodes on the network, via the Internet.

An intrusion can be defined as a set of actions that attempt to compromise the integrity, confidentiality or availability of a resource, and many different types of intrusion detection model have been proposed in recent years. Such intrusion detection models can be characterised by performance metrics, such as the proportion of false positive (a legitimate action which is incorrectly flagged as an intrusion) and false negative (an illegitimate action that is regarded as a legal operation) detections that a system produces, as well as its susceptibility to subversion errors (successful attempts by an attacker to manipulate the system such that the proportion of false negatives is increased). Although different implementations of an intrusion detection (ID) model are likely to have varying false positive and false negative proportions, the range of values is largely fixed by the model itself.

The two most common ID models are anomaly and misuse detection. The misuse paradigm is straightforward in the sense that the intrusion detection system (IDS) has some knowledge of suspicious behaviour and looks for actions that match this knowledge. Such knowledge is typically represented as a set of signatures, where each signature encapsulates the salient features of a different attack or class of attack. The primary advantage of this model is that the proportion of false positive detections is low and can be reduced by lengthening each signature (i.e. specifying each attack in more detail). A drawback of this model, however, is that the proportion of false negative detections can be high, depending on the limitations in the knowledge contained within the list of signatures. This model requires human intervention for automatically updating its knowledge and keeping the signature list up-to-date. This process is time-consuming and prone to human error, and although subversion errors are minimal, they are not eliminated completely.

Further, it is difficult to encode contextual information in the misuse model. This leads to a type of false positive detection in the sense that an attack against a particular architecture or operating system is detected, but the target is neither of these, thereby rendering the attack benign. Many misuse models do not provide suitable syntax for associating certain signatures with specific targets. In addition, systems that implement the misuse model typically only provide basic pattern matching features, such that an attacker may be able to bypass an DS by obfuscating a known attack slightly so that it no longer matches the signature. This highlights a major drawback associated with the misuse model, namely that signatures are stored and matched against in a syntactic manner.

The other common intrusion detection paradigm is known as anomaly detection. In this model, the system has knowledge of normal behaviour and looks for exceptional activity. Normal behaviour is defined in terms of metrics recorded when the system is running routinely. If the IDS is concerned with specific user activity then the set of metrics may include the number of processes running and the number of files open, whereas if the UDS is monitoring a system as a whole, the set of metrics may include CPU usage, the number of network connections open, and sequences of system calls. The main advantage of the anomaly-based model is the low proportion of false negative detections made, which can be reduced further by increasing the sensitivity to changes in the metrics. Unlike the misuse model, this model can potentially identify previously unseen attacks. In addition, once the system has been trained, it requires less human intervention than the misuse model, because it can automatically suggest updates to its knowledge (based on previous system activity). However, this substantially increases the threat of subversion errors. Further, an attacker may even be able to weaken the system from the start by attempting intrusions whilst the system is learning normal behaviour.

The principal disadvantage of this system, however, is the high proportion of false positive detections, since an intrusion will usually generate abnormal behaviour, but abnormal behaviour is not necessarily the result of an attack.

Most commercial intrusion detection systems implement the misuse model as it requires little customisation for the environment it operates in and no training. It is also favoured because of its low proportion of false positive detections, since it will be appreciated that the usefulness of an intrusion detection system might be severely reduced if it produces so much information that serious intrusions cannot be identified in reasonable time.

In the case of both of the above-described models, the IDS is able to learn additional information (obtained from an analysis of previous operation) so as to achieve a larger knowledge base and better performance (i.e. detection of more attacks). In the misuse model, a substantial amount of human intervention is required in connection with analysis of previous attacks and encapsulation of newly-discovered attacks or classes of attack within a signature to input to the model. Computationally, this process is fairly simple, provided the information is provided to the system in the correct form—all the system is required to do is memorise the new information, no inference or additional manipulation is necessary. However, it will be appreciated that including too much information in each signature or having a signature list which is excessively long may result in the system being unable to keep up with incoming traffic, causing a backlog to form and causing the system to drop traffic or even fail altogether.

In the anomaly-based model, a much more autonomous form of learning takes place, in the sense that human input is required to provide basic knowledge as the starting point for the system. From here, the system then updates its knowledge base according to its own criteria. However, in view of the lack of human intervention during the learning and knowledge base updating process, and the fact that this learning process is based on the user s initial intentions (which may change over time depending on activities occurring on the network), it is relatively easy for a potential attacker to influence this process, resulting in the occurrence of an unacceptable number of subversion errors.

We have now devised an arrangement which overcomes the problems outlined above. Thus, in accordance with a first aspect of the present invention, there is provided an intrusion detection system for detection of intrusion or attempted intrusion by an unauthorised party or entity to a computer system or network, the intrusion detection system comprising means for monitoring activity relative to said computer system or network, means for receiving and storing one or more general rules, each of said general rules being representative of characteristics associated with a plurality of specific instances or a specific type of intrusion or attempted intrusion, and matching means for receiving data relating to activity relative to said computer system or network from said monitoring means and for comparing, in a semantic manner, sets of actions forming said activity against said one or more general rules to identify an intrusion or attempted intrusion.

Thus, in the system of the first aspect of the present invention, the knowledge base conveys semantic information about classes of attacks, and contains general rules as opposed to specific instances, thereby enabling the system to perform a semantic matching process (as opposed to the syntactic matching process used in the prior art), so as to improve system performance and minimise the false positive detections, false negative detections and subversion errors to which conventional security systems are prone.

In accordance with a second aspect of the present invention, there is provided an intrusion detection system for detection of intrusion or attempted intrusion by an unauthorised party or entity to a computer system or network, the intrusion detection system comprising means for monitoring activity relative to said computer system or network, means for initially receiving and storing a knowledge base comprising one or more general rules, each of said general rules being representative of characteristics associated with a plurality of specific instances of intrusion or attempted intrusion, and means for automatically generating and storing in said knowledge base (after said knowledge base has been initially stored) a new general rule representative of characteristics associated with specific instances of intrusion or attempted intrusion not previously taken into account.

It will be appreciated that, for the purpose of the present specification, the term intrusion detection system is intended to encompass all types of computer security application, including intrusion detection systems, firewalls and virus checkers and scanners.

In accordance with a third aspect of the present invention, there is provided an intrusion detection system for detection of intrusion or attempted intrusion by an unauthorised party or entity to a computer system or network, the intrusion detection system comprising means for monitoring activity relative to said computer system or network, means for initially receiving and storing in a knowledge base data representative of characteristics associated with one or more specific instances or classes of intrusion or attempted intrusion, matching means for receiving data relating to activity relative to said computer system or network from said monitoring means and for comparing sets of actions forming said activity against said stored data to identify an intrusion or attempted intrusion, and inductive logic programming means for updating said stored data to take into account characteristics of further instances or classes of intrusion or attempted intrusion occurring after said knowledge base has been initially received and stored.

Thus, the present invention, in general terms, provides an intelligent computer system intrusion detection system which, in some aspects, uses machine learning techniques to suggest updates to its list of detection rules by processing records of intrusion attempts (successful and unsuccessful).

In one embodiment, the present invention extends the misuse intrusion detection paradigm (described above) to create an IDS that searches computer input traffic in a semantic matching manner to determine the contextual function of the traffic, as opposed to simple signature matching of known sinister traffic (or syntactic matching). Representing the knowledge base of matching rules in a logic programming language, in a preferred embodiment, allows for greater flexibility and for combination with other types of information (e.g. contextual information about the host computers that the DS is attempting to protect).

The second aspect of the invention preferably uses Inductive Logic Programming techniques (ILP—a form of machine learning), described below, to suggest new intrusion detection rules for inclusion into the system, based on examples of sinister traffic. This not only frees the IDS administrator from having to manually analyse new attacks, but it also means that suggested rules benefit from the semantic matching referred to above.

The invention is based on the fact that it considers the functions that the computer input is likely to perform on the target computer rather than searching for a known form of attack inputs. The invention considers what the result of the input to the computer will be rather than what it looks like. By representing both the input and the protection rules in a form that encodes the function from the form allows higher level reasoning about the input, and the prediction of its likely function on the computer. Such a form is as a logic program. The construction of the logic program that represents the knowledge base of the rules of an IDS according to an exemplary embodiment of the invention is described below.

The second aspect of the invention in particular is a process by which the IDS can automatically improve the protection it offers by learning new protection rules. These new rules are learnt (in a preferred embodiment) by applying ILP to attacks that breach, or nearly breach, to the existing DDS.

As explained above, conventional intrusion detection systems implement one or two models; the misuse model or the anomaly model. The anomaly model is of little commercial value at present, for reasons set out above. The misuse model is the most prevalent model but it has many limitations. Representing the knowledge base from a misuse IDS in a logic programming language (according to a preferred embodiment of the invention) allows one to circumvent many of these restrictions. The ILP technique, referred to in accordance with a third aspect of the present invention, follow on as a useful extension. No other IDS can induce or generate a general rule given some new examples of attacks.

An embodiment of the present invention will now be described by way of example only and with reference to the accompanying drawings, in which:

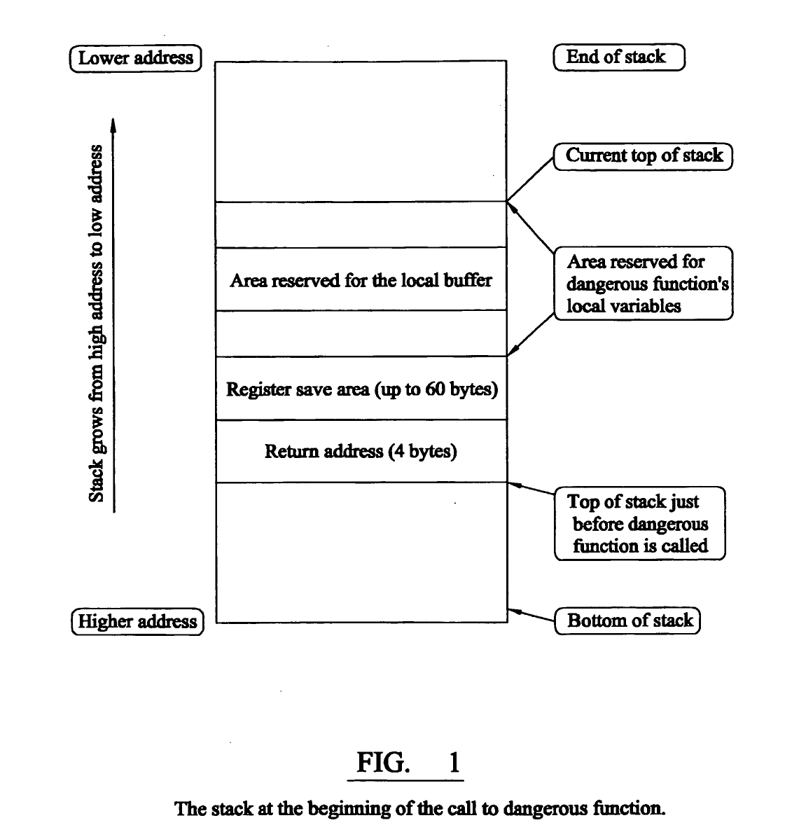

FIG. 1 is a schematic block diagram illustrating a stack at the beginning of a call to a dangerous function;

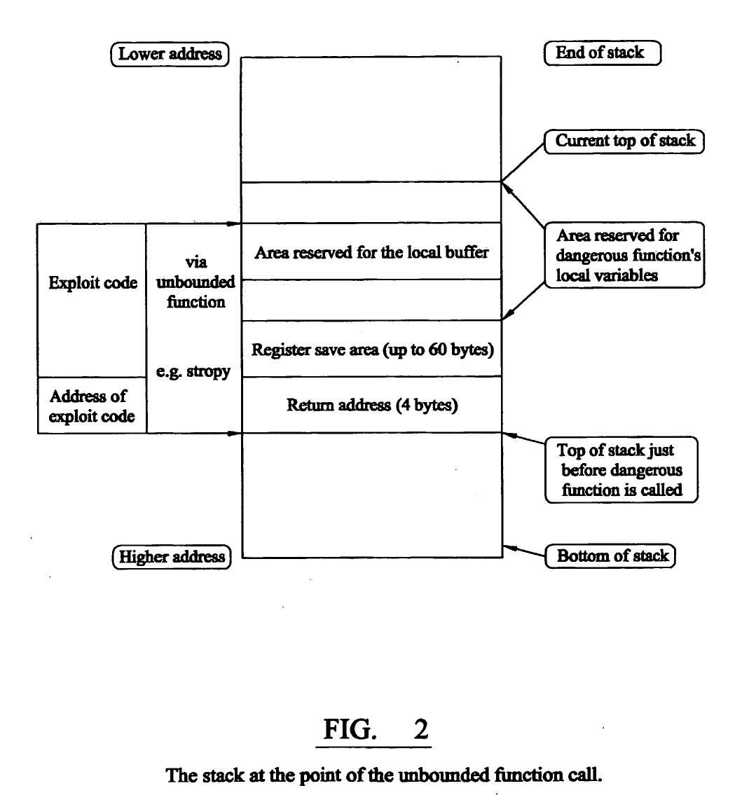

FIG. 2 is a schematic block diagram illustrating a stack at the point of an unbounded function call;

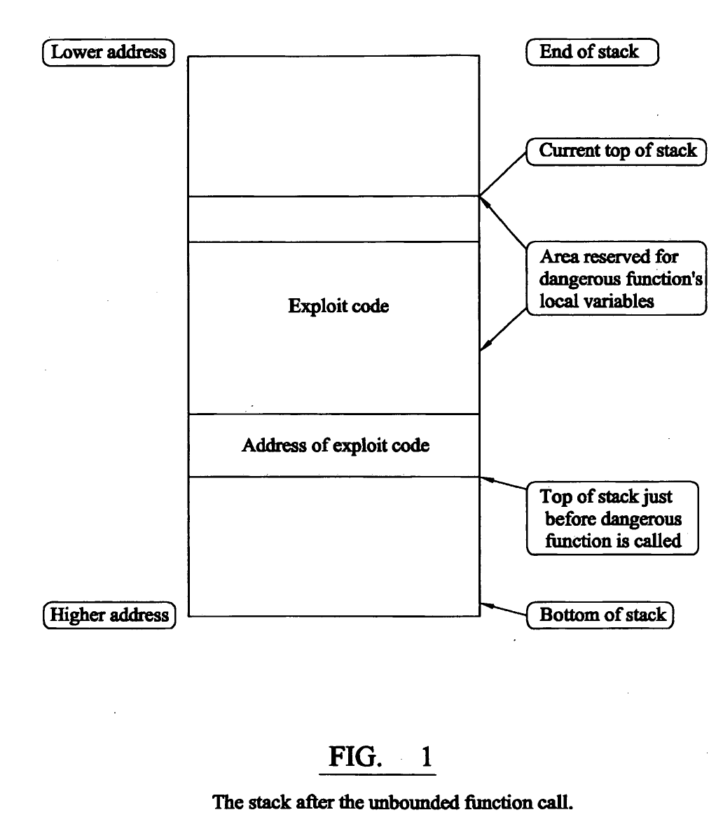

FIG. 3 is a schematic block diagram illustrating a stack after an unbounded function call;

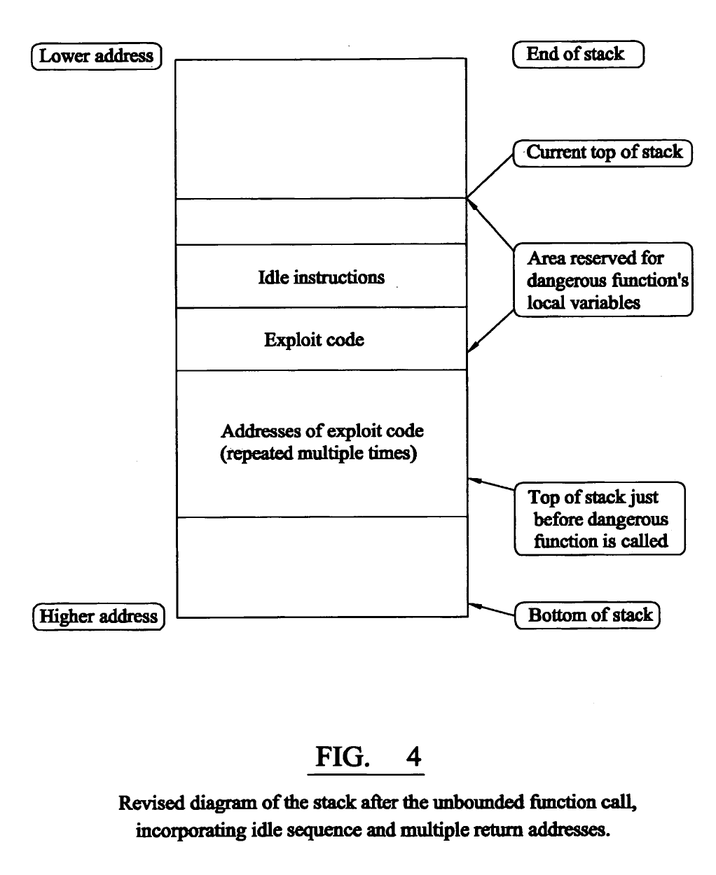

FIG. 4 is a revised version of FIG. 3, incorporating idle sequence and multiple return addresses;

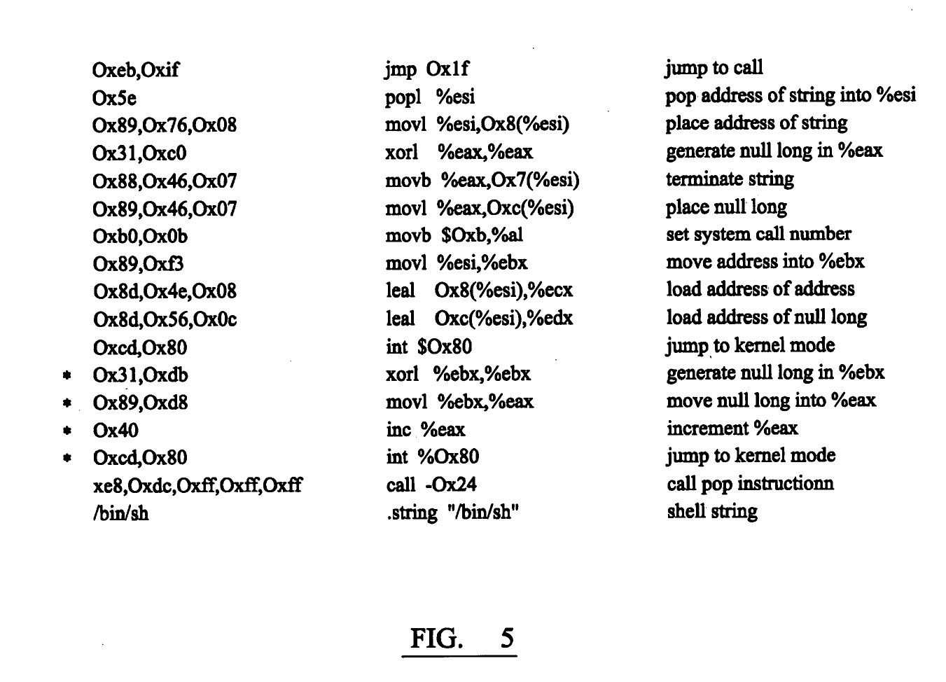

FIG. 5 illustrates common x86 Linux shell-code with disassembly;

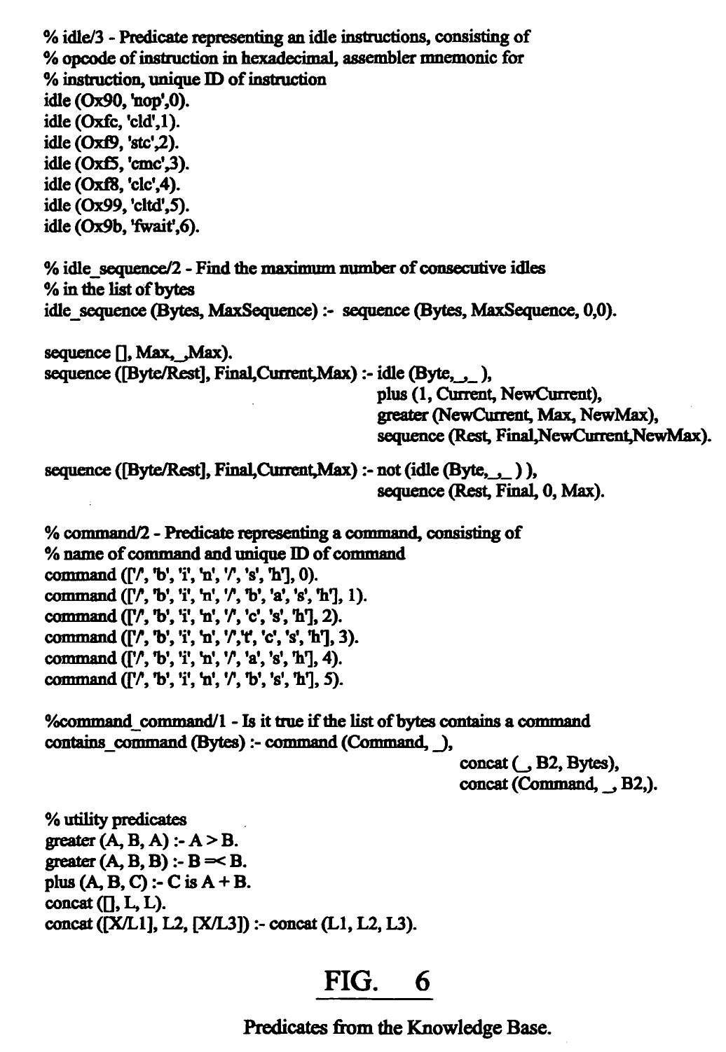

FIG. 6 illustrates some of the Prolog predicates used to represent the knowledge base in this exemplary embodiment of the present invention;

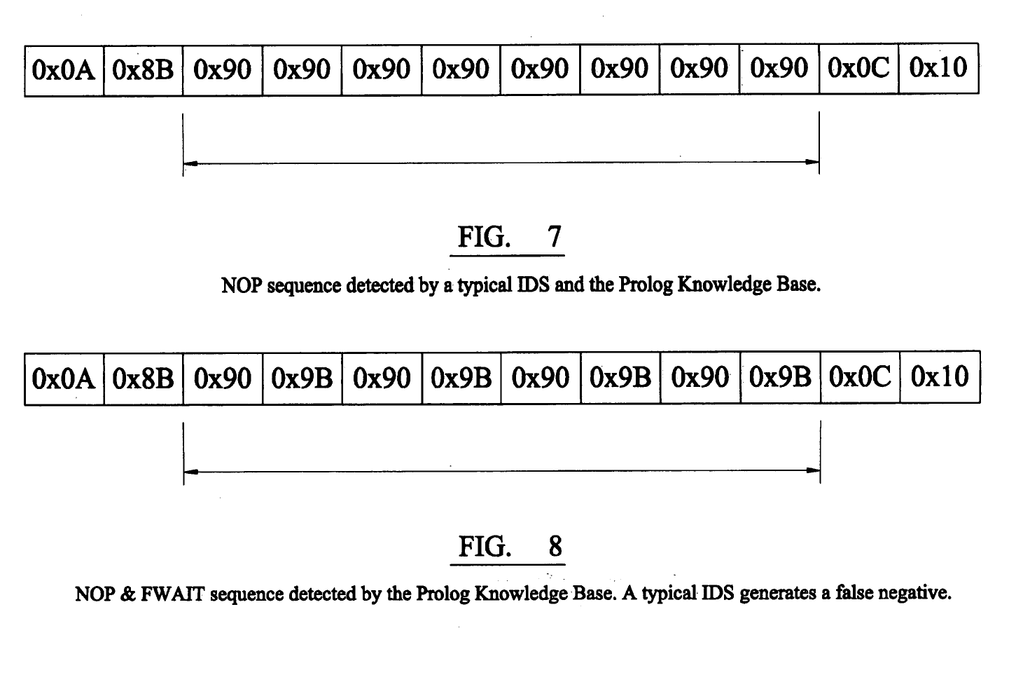

FIG. 7 illustrates the NOP sequence detected by a typical IDS and the Prolog Knowledge Base;

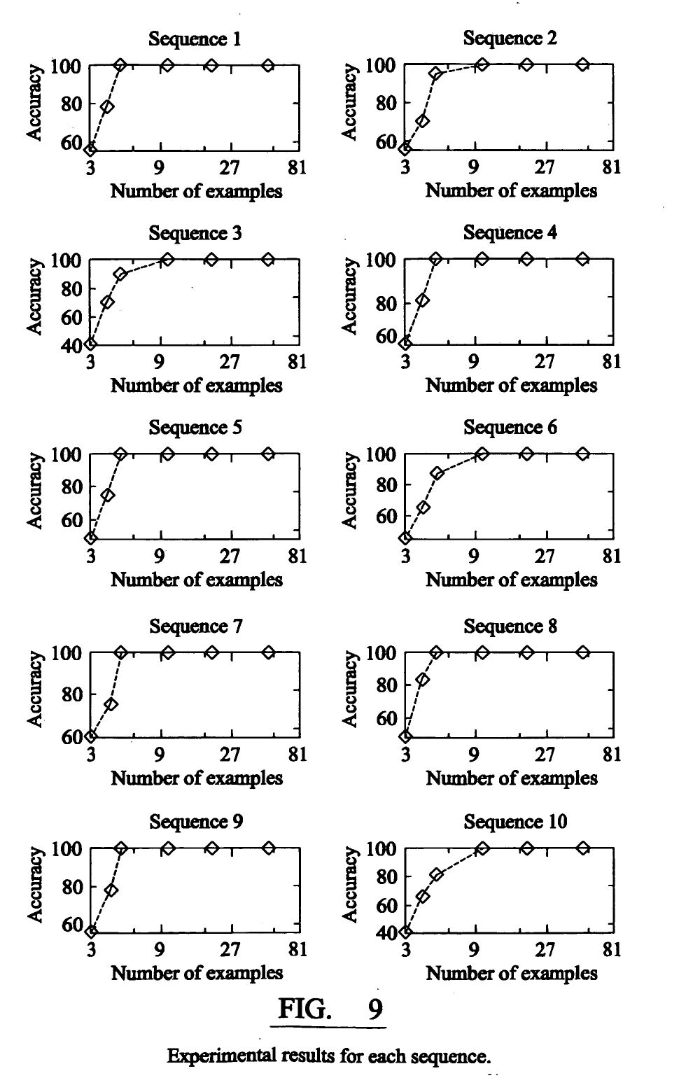

FIG. 8 illustrates the NOP and FWAIT sequence detected by the Prolog Knowledge Base but not by a typical IDS;

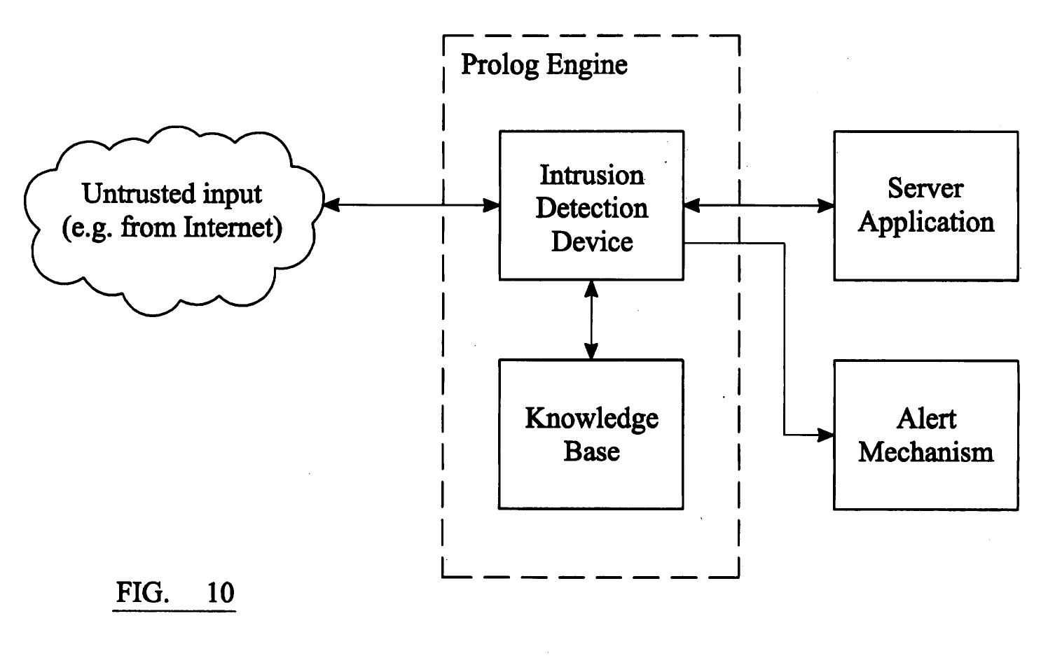

FIG. 9 is a set of graphs illustrating experimental results; and

FIG. 10 is a schematic block diagram of an intrusion detection system running on a Prolog engine.

The following description presents a basic knowledge base for an intrusion detection system according to an exemplary embodiment of the present invention. The described knowledge base contains information about a single class of security flaw, the input validation error, present in most vulnerability taxonomies, whereby the word taxonomy may be defined as [symbol] the science or practice of classification [symbol] , and a vulnerability may be defined as [symbol] a feature or bug in a system or program which enables an attacker to bypass security measures [symbol] .

One known class of vulnerability relates to incomplete input validation; the most common form of which is the buffer overflow. The circumstances in which a buffer overflow can occur are well understood in the art and wholly avoidable if the software is developed according to one of many secure programming checklists. Although known modifications to develop and runtime environments have been proposed in the past, which modifications are designed to detect vulnerable code and constrain buffer overflow attacks, few such systems are in widespread use, often due to the high overheads associated with them, and without runtime measures to protect against buffer overflow attacks, the need for intrusion detection is increased.

The concepts behind exploiting a buffer overflow vulnerability are simple but the implementation details are subtle.

Buffer overflow attacks exploit a lack of bounds checking on some user-supplied parameter; that is, an overly large input is copied into a buffer of a fixed size and as a result, memory located immediately after the buffer is overwritten with the remainder of the input. The majority of attacks exploit buffers that have been allocated on the stack, although heap-based buffer overflows are also possible. The memory that is overwritten by a portion of the user input may have held other data structures, the contents of registers, function pointers, or a procedure return address. It is the latter that is of interest to the attacker. FIGS. 1 to 3 illustrate how the stack is modified when a buffer overflow attack is successful; that is to say, when a vulnerable program calls a dangerous function with the attacker s input.

Before the program executes the dangerous function call, the return address is pushed onto the stack so that execution can continue from the correct place once the function is complete. Register information is then pushed on to the stack so that the original state can be restored. Space for variables local to the dangerous function are allocated once execution of the dangerous function begins. The attacker supplies an overly large input hoping to overwrite the return address (if he is unable to do this, he may still be able to overwrite values in the register save area; this may or may not allow him to execute his exploit code, depending on later instructions contained in the program). FIG. 2 simplifies things somewhat; the attacker is likely to supply a sequence of idle instructions at the beginning of the exploit code, and multiple copies of his desired return address at the end of the exploit string, to increase the changes of the exploit succeeding.

After the unbounded function call, the exploit code has been transferred to the space allocated for the dangerous function s local variables and the register save area. The address of the start of the exploit code has overwritten the return address. Once the dangerous function has completed, values from the (overwritten) register save area are popped off the stack back into system registers and execution continues from the new return address, executing the attacker s code.

For the attacker to correctly build the exploit string, he must know some basic properties of the target system:
the processor architecture of the target host (since machine code instructions have different values in different processors)
the operating system the target is running (since each operating system has a different kernel and different methods of executing kernel (system) calls)
where the stack for each process starts (fixed for each operating system/kernal) approximately how many bytes have been pushed onto the stack prior to the attack

This description is limited to the discussion of buffer overflow exploits for the Intel x86 family of processors running the Linux operating system, although the application of the detection techniques presented in this specification to other processors and operating systems is discussed later.

The following part of the description concerns itself with building a knowledge base that contains information about input validation errors. It is useful to formulate a general approach for representing any class of vulnerability in a semantic manner; that is effectively a knowledge engineering task, and the representation process is outlined below:
1. Determine the domain of the class of vulnerability; that is the set of attributes, relations and facts from which the attack can be described. This may include protocols, machine instructions and sets of files.
2. Determine any constrains that narrow the domain (often inherent to the particular kind of attack).
3. Determine the goal of the attacker and express this in an appropriate form (e.g. in natural language).
4. Use a top-down approach to repeatedly reduce the goal(s) into subgoals, until each subgoal can be represented in a suitable manner (e.g. as a sequence of instructions in a protocol or low-level language). Use of real world examples may help in deciding how to subdivide goals.

The buffer overflow attack can be represented according to the steps defined above.

The domain of this class of vulnerability is the set of machine code instructions on the target architecture (Intel x86). Although the exploit code can feasibly contain any valid opcode (subject to the constraints discussed later), there is only a small subset of instructions that the attacker is likely to use. This subset is likely to include register manipulation instructions (e.g. to move a value from one register to another), stack operations (to push and pop values off the stack) and basic arithmetic operations (e.g. to increment a register). The domain also includes the set of commands on the system that the attacker almost certainly have to make use of to accomplish his goal. This set is significantly reduced once the goal of the attacker has been determined. Operating system specifics must also be included in the domain; in the case of the Linux operating system, the procedure in which system calls are set up and executed should be included:
1. place system call number in register % eax
2. place parameters in % ebx, % ecx, % edx respectively
3. trigger software interupt 0×80 to jump into kernel mode

It is well known that one user identification, called the super-user (or root), has special power and may violate many of the protection rules [set by the operating system]. Many ordinary users devote considerable effort to trying to find flows in the system that allow them to become super-user without the password. This is often achieved by exploiting a vulnerable program in order to execute a code that gives access to a command interpreter, known in Unix-based operating systems as a shell, from which other commands can be issued. The term shell code will be used interchangeably with exploit code to refer to the part of the exploit that contains the instructions that the attacker wishes to execute. The shell that the attacker opens will inherit the file descriptors of the original program; if the process was started locally (i.e. the attacker logged into the system first) then the standard input and output of the original program become those of the command interpreter. If however, the attack occurs remotely (e.g. the attacker exploits a vulnerable server application) then the attacker must take steps to ensure communication with the shell also occurs remotely; this involves supplying instructions in the exploit payload to bind the command interpreter to a network port to which the attacker can connect. This specification only considers local exploits (i.e. with the attacker being logged onto the system by some means). The set of system commands that form part of the domain therefore only contains the shells that are present on the target.

The null byte problem states that the exploit code will not contain any bytes whose value is zero. This is because the functions that allow buffer overflows to occur, typically string operations such as strcpy and strcat, treat a zero byte as a strong terminator. If the exploit code contains a zero byte, any bytes after it will not be operated on. This constraint has other implications; the sequence of characters representing the shell to be executed (e.g. /bin/sh) cannot be terminated which means the exploit code itself must itself generate and place a zero byte after it in memory so that it can be treated as a string.

The exploit code must contain the relevant instructions to execute the exec system call. This is because the goal of the attacker (to open a shell) is predetermined. In the Linux operating system, systems calls are carried out by placing the call number in the register % eax (and appropriate parameters in subsequent registers % ebx, % ecx and so on) then triggering software interrupt 0x80 which causes the system to jump to kernel mode. The system call number of exec is standard across all Linux kernels.

The set of instructions in the exploit code must not contain any hard-coded addresses since this will greatly reduce the chances of the exploit succeeding. The only hard-coded address in the complete exploit string must be the return address. Since the address of the sequence of characters representing the shell is required, the exploit code must contain instructions to indirectly load this address into a register.

The previous constraints can be classified as hard constraints since they specify what must and what must not occur in the input. It is also possible to define soft constraints, that is, conditions that can only be stated in a fuzzy manner. An example of a soft constraint concerns the length of the exploit code. As can be seen from the stack of diagrams, there is a limited amount of space for the exploit code to occupy before the return address is reached. If the exploit code is larger, the return address will be set to the value represented by the four bytes of instruction code that happen to have been copied there and the attack will fail (the vulnerable software will almost certainly crash but the attacker will not accomplish his goal). A length constraint therefore states that the size of the exploit code must be smaller than the amount of memory before the return address. Of course, the latter may only be estimated and so this constraint can be paraphrased as stating that the attacker must write to exploit code to be as compact as possible.

A final soft constraint states that the exploit code is likely to be prefixed by a number of instructions that have no purpose except to idle the processor. Idle instructions are used to reduce the uncertainty of guessing the correct return address. If there are no idle instructions the return address must be set to the beginning of the exploit code; this requires a perfect knowledge of the state of the process stack. By including a sequence of idle instructions at the start of the exploit code, the return address need only be set to an address within this sequence; this greatly improves the chances of an exploit succeeding. This sequence of idle instructions is often referred to a a NOP sledge (NOP is the opcode that represents a no operation instruction within the CPU). FIG. 4 shows a more realistic layout of the stack after an unbounded function call has completed containing a NOP sledge and multiple copies of the return address. The number of idle instructions that prefix the exploit code may be variable depending on the attacker s knowledge of the layout of the stack. Early buffer overflow exploits only used the NOP opcode in creating a sequence of idle instructions. This, however, is easily detectable by pattern matching. Recent exploits use instructions that are deemed to be idle within the context of the exploit. An example of an idle instruction therefore, might be some arithmetic operation on a register which is not referenced in the exploit code. The attacker may also decide to use multi-byte instructions (i.e. the opcode and operand take up more than a single byte) as idle instructions. This reduces the chances of the exploit working (since the return address must now contain the address of the first byte of a multi-byte instruction) but if the circumstances are such that the attack can be repeated multiple times then this method can be successful.

Summary of Constraints

due to the uncertain constraint, there will be a sequence of idle instructions

as there can be no hard-coded address, there will be code to indirectly load address of the shell string into a register; this code will be near the start of the exploit code

1 due to the Linux method of executing a system call there will be code to set up the parameters then jump into kernel mode; this will make up the last few instructions in the shellcode
2 code prior to the setting up of the system call with null-terminate the sequence of characters representing the shell; this involves sub-steps of generating a zero byte inside a register and moving the zero byte to the address of the end of the sequence of characters

For the following section of the description, it is useful to express instructions in assembly language, a low level symbolic language in which instructions correspond to sets of machine language instructions. Although forms of assembly language differ according to the family of processor the language describes and also in syntax, porting assembler from one form to another is a relatively simple task. It may even make sense, depending on the domain of the problem, to express the natural language descriptions in some pseudo-code before a specific platform is considered.

Some example shell-code is reproduced in FIG. 5, together with a disassembly and commentary on the instructions. This example satisfies each of the constraints above and has been used as the basis for many real world exploits (such is its portability that it can almost be dropped into any x86 Linux buffer overflow vulnerability). This example was used as a basis for the buffer overflow representation.

The natural language description of this class of vulnerability can be expressed in a logic programming language. This allows for a separation of the logic component (the representation of the class of vulnerability) from the control component (how the representation is matched against). The Inductive Logic Programming (ILP) engine utilises the logic programming language Prolog (in this exemplary embodiment) as its concept description and discovery language; to facilitate the ILP experiments, the buffer overflow attack is also expressed in Prolog.

FIG. 6 shows some of the Prolog predicates that are used to represent the knowledge base that holds information about buffer overflow attacks. The procedural meaning of the predicates is that the first argument is the sequence of bytes received, in the form of a list, and the second argument is the suffix of the first list of bytes, the prefix part having been consumed by the predicate. Any other arguments represent additional parameters (e.g. register numbers and offsets) that the predicate requires to consume the input.

The predicates in the knowledge base have equivalent rules in a typical misuse-based IDS. The contains-command/1 predicate is equivalent to a set of rules, each pattern matching a different command. The idle-sequence/2 predicate however, cannot be represented succinctly in the IDS rules. It detects sequences of idle instructions, where an idle instruction is defined by the predicate idle/3. The IDS may have a signature that detects a sequence of NOP opcodes as shown in FIG. 7 but if the NOP opcode is interspersed with FWAIT instructions (FIG. 8) then the signature will fail; the idle_sequence/2 predicate however, will succeed. Note that FWAIT is an opcode which causes the processor to check for and handle pending floating-point exceptions before proceeding. In the context of a buffer overflow attack, this operation can be regarded as an idle instruction.

The set of predicates allow a more thorough representation of the facts that may be found in an IDS rule set. However, used disjointly, the false positive detection rate will match that of a typical IDS. This can be lowered by combining facts using conjunction:
% is_bufferoverflow/2—checks for a sequence of 128 idles and checks
% whether list of bytes contains command
is_bufferoverflow (Bytes):—idle-sequence (Bytes,128) contains_command (Bytes).

Contextual information can easily be encoded in Prolog. The example predicate below encapsulates informtion about the operating system that a specific host is running; the processor type and any services that are operational.
% host_info/4—contains useful information of a specific host
% arguments are: name, processor, operating system [services]
host_info (workstation1, intel, linux,]ftpd, sshd]).
host_info (server1, dec_alpha, windows, [ftpd, httpd]).
host_info (workstation2, sparc, solaris, [ ]).

This predicate can be used in conjunction with the intrusion detection predicates:
% Example use of host_info
% Check target is Intel based
% and check for sequence of 128 idle instructions
intel_idle_sequence (Host, Byte):—host_info (Host, intel,_,_)
   idle_sequence (Byte, 128).

The false positive detection rate can be reduced further if more of the input can be parsed. This is accomplished by providing additional predicates. The false negative detection rate, however, is likely to increase since although a large variation of byte sequences will be correctly classified, the structural properties of the exploit code are fixed by the order in which the lower level predicates appear in the higher level predicates. A simple solution is to add more predicates that cover variations in the exploit code structure but this requires substantial human effort. The present invention is concerned with new real world examples which can be automatically expressed using the background information already encapsulated in the knowledge base.

The following description introduces the theory and techniques of Inductive Logic Programming by means of a simple example.

Typically, an ILP system will contain some background knowledge, a set of positive examples and either a set of negative examples or a set of unclassified examples. The background knowledge is information that is known to the learner before the learning starts and is considered correct; it is encoded as a Prolog program. This enables the human to provide a natural, domain-specific representation of what is known about the problem and also to convey any inherent constraints. The formulation of the background theory should be performed by an expert.

The ILP system takes as input a) an existing IDS knowledge base (including all relevant utility predicates) as background knowledge B; and b) examples of known intrusions E (which are not detected by B); and provides as output suggested new intrusion detection rules H, which when combined with B allow the examples (as well as those generated by a similar attack strategies) to be detected by the updated IDS knowledge base.

The basic algorithmic steps involved in the ILP system are outlined as follows.
1. Select example. Select an example of an attack to be generalised. If none exist, stop, otherwise proceed to the next step.
2. Build most-specific-rule. Construct the most specific rule that logically entails the example selected, and is within any language restrictions provided.
3. Search. Find a rule more general than the most-specific-rule. This is done by searching for some subset of the conditions in the most-specific-rule that has the best score.
4. Remove redundant. The rule with the best score is added to the current list of new rules, and all examples that can now be detected with that list of new rules are removed.
5. Return to Step 1.

When the process is completed, the administrator can review the new IDS rules and if so choose to apply them in his intrusion detection system. Thus, it can be seen that ILP techniques are of use in the domain of intrusion detection, by assisting the expert in adding to the DS knowledge of new attacks that can be explained using a rule constructed from an existing IDS knowledge base. Without this machine assistance, the expert must manually analyse new attacks that the IDS knowledge base cannot adequately detect and propose his own IDS rules. He may be tempted to append the existing IDS knowledge base with a syntactic signature specific to the new attack(s), as would be found in an IDS that implements the misuse model. This however, does not benefit from the semantic information already contained in the knowledge base. The expert may propose a rule on a hunch, composed of background theory predicates that explains a good number of the new attacks. However, another expert analysing the same attacks may argue for different rules. The IDS that allows analysis using ILP techniques automatically proposes the best rule (with respect to some scoring function) which the expert can directly add to the knowledge base, or at least use as a starting point.

Firstly, the techniques must work with a limited number of positive examples. In this domain, a positive example is a new attack. New attacks are likely to come from two sources; the expert may be able to extract them from logs of network traffic or they may come to light within the computer security community. When analysing the logs of network traffic, the distribution of new attacks is likely to be heavily skewed. A large proportion of the logs will constitute valid traffic and the expert may have to use computer forensic techniques (e.g. analysing the state of compromised machines on the network) in order to locate the attacks in the logs. He may uncover traffic that he thinks warrants further analysis yet he is not certain it is an attack. Similarly he may not be certain he has identified every attack in a given log file. It is for these reasons that the experiments presented in this chapter were carried out using positive-only learning. This setting is typically used in ILP applications that work with natural language. Two sets of examples are used; the first set contains examples that have been identified as valid attacks (positive examples), the second set contains unclassified examples that the expert thinks are worth including. These are called near misses. Attacks that have been discussed by the security community may be more suited to positive-negative learning since the expert has a clear classification of examples. A practical requirement of the system is that it must return its findings within reasonable time. An attack that is self-multiplying (a so-called worm) can spread through an unprotected network extremely quickly; if the IDS cannot suggest a rule covering the attack in reasonable time (most likely the order of minutes) the expert may be forced to add a typical misuse model signature (thus losing out on the benefits of representing the attack semantically). The expert must also know in reasonable time whether the background theory is incorrect (or incomplete) with respect to the new attacks.

The accuracy of the hypothesis proposed by the system must be such that the rule, if not suitable for addition to the knowledge base in its initial form, is still of use to the expert. The amount of post-processing the rule requires to make it suitable for inclusion into the knowledge base must not exceed the amount of work required to manually analyse the attack.

Some informal descriptions of some of the variations in attack strategy relevant to this exemplary embodiment of the invention are given below.

Attack Strategy 1. The sequence starts with idle instructions, performs a jump-call-pop subsequence to get the address of the string then puts the string address in the required place. It then generates a null long which it uses to terminate the string and complete the array. The system call number is then set up (parameter 1) then the remaining parameters are set up before the system call is executed.

Attack Strategy 2. This sequence is a variation on sequence 1. Instead of putting the address of the string in the required place as soon as the address is obtained, the null long is generated and dealt with first. Parameters are then set up and system call executed as in sequence 1. This sequence reduces the possibility of matching syntatically on the idles, jmp-pop, put addr subsequence of sequence 1.

Attack Strategy 3. This sequence is different from sequences 1 and 2 because the first operation after the idles is to set up the null long. Then it generates the string address via jmp-call-pop (obviously this time the jmp-call-pop operation cannot simply choose any register in which to load the string address). The rest of the sequence is the same as sequence 1. This sequence reduces the possibility of looking for jmp-call operations at the outer edges of the shellcode, as are typical.

In the context of buffer overflow exploits, new attack strategies are likely to consist of variations in shell-code structure or shell-code containing additional features (e.g. placing a decoder at the start of the shell-code and encrypting the remaining bytes).

Experiments have been carried out and each experiment considered examples of one type of attack strategy. The examples were generated by manually creating a predicate representing the variation (i.e. a rule towards which the system should be aiming) and rewriting certain background predicates so that their declarative and procedural meaning allows them to operate in reverse; this required additional predicates that allowed pseudo-random choices to be made. The complexity of the context-dependent grammar of attacks meant that the example generation predicates did not succeed every time. For this reason each example was automatically tested by wrapping the shell-code in a small C program, compiling, executing it and verifying that it correctly opened a shell.

For each experiment a successive number of positive examples (3, 4, 5, 10, 20, 50) were randomly selected from a set of size 100. The standard Inverse Entailment algorithm that Aleph implements (described previously) was applied and the hypothesis space was estimated. The graphs in FIG. 9 illustrate that it is possible to induce a rule that covers 100% of the examples in the set using on average, a low number of examples for the induction. This can be attributed in the experiments to the relatively low size of the hypothesis space, which was a result of the high input and output connectedness of the background predicates (this also meant that the requirement of returning a rule in reasonable time was also satisfied). This result demonstrates that ILP may well have interesting application in real world intrusion detection problems, provided the background theory is sufficient; these experiments indicate that the background information contained in the knowledge base was highly accurate and relevant.

A buffer overflow detector is described above which is based on the revised misuse model and takes the form of a Prolog program. An extension would be to provide buffer overflow detection for other operating systems and architectures. Common architectures (e.g. processors from the Intel x86 family) share the same opcodes, regardless of operating system. This means that some predicates (e.g. the idle sequence detector) need not be rewritten. Predicates that are operating system specific (e.g. those that express how a system call is executed) require modification but rather than using new predicate symbols, additional arguments could be added to each predicate to specify architecture and operating system (since the concept of the buffer overflow attack remains unchanged). Once input validation attacks are fully represented, other major classes of vulnerability (e.g. configuration errors and synchronisation errors) could be expressed in Prolog using the approach given above and ILP techniques applied.

The Prolog system used in the above described exemplary embodiment is shown schematically in FIG. 10. If the intrusion detection rules in the knowledge base detect an attack then the Prolog engine can notify the system administrator that an intrusion attempt may be in progress. Depending on the system security policy, the decision of whether to forward traffic to the service could be delegated to the intrusion detection system itself so that potentially harmful input never reaches the target. This is an example of active intrusion detection, as opposed to the traditional passive paradigm.

The proposed active IDS blurs the boundary between the role of the firewall (a system designed to prevent unauthorized access to or from a private network), and the intrusion detection system. Most firewall rule sets allow reasonably complex filters to be defined based on packet attributes (e.g. source and destination address, port and the packet s flags) but few provide anything more than basic pattern matching on the payload of the packet (this is known as content filtering). The Prolog IDS allows for semantic matching as discussed above as well as representation of contextual information (e.g. what operating system a certain host is running and what patches have been applied). If the IDS were to be deployed as a form of firewall then packet information could be represented very easily, since Prolog is well suited to modelling systems of related objects, each of which has a set of attributes. This allows the administrator to define intrusion detection predicates that combine advanced content matching, contextual information and packet attribute data. This type of IDS could be implemented in a Prolog system that provides an interface for a common programming language such as C (to allow for low level network access to read in the packet) and a bridge to allow for interaction with relational databases (to manipulate each packet s set of attributes). Checking for computer virii is analogous to detecting intrusions. Most virus checkers implement the misuse model; that is, they have a signature for each virus and perform pattern matching on the file. Some virus checkers offer heuristic scanning (i.e. Norton Antivirus). Files are assigned a probability that they are harmful based on certain characteristics. Heuristic scanning has had particular success with macro-virii (a malicious macro embedded in a document) and script virii for the Windows platform (typically transferred by email clients). It is more difficult to determine whether an arbitrary executable file is malicious since its structure is more complex. An extension to the second aspect of the invention would be a hostile code analyser, written in Prolog, that is able to improve its performance using ILP techniques (utlising the third aspect of the invention).

Thus, the above description relating to the present invention essentially revolves around two main concepts. The first is representing the knowledge base (whether it be for an intrusion detection system, hybrid firewall or virus checker) in a logic programming language such as Prolog (as in the first aspect of the invention). This allows for a flexible representation of both sequential and relational information. The second concept is using the information contained in the knowledge base as background theory for Inductive Logic Programming techniques (as in the third aspect of the invention). This allows for further rules to be added to the knowledge base, based on new examples. The semantic representation of new attacks means that there is a high chance that mutations of the attack, that inevitably occur, are already covered.

To conclude, the combination of these aspections of the invention is considered to be particularly well suited to computer security applications, particularly those that must assimilate new information that is only available (initially) in example form.

Although a specific exemplary embodiment of the present invention has been described above, it will be appreciated by a person skilled in the art that modifications and variations can be made to the described embodiment without departing from the scope of the invention as defined by the appended claims.

1. An intrusion detection system for detection of intrusion or attempted intrusion by an unauthorised party or entity to a computer system or network, the intrusion detection system comprising means for monitoring activity relative to said computer system or network, means for receiving and storing one or more general rules, each of said general rules being representative of characteristics associated with plurality of specific instances of intrusion or attempted intrusion, and matching means for receiving data relating to activity relative to said computer system or network from said monitoring means and for comparing, in a semantic manner, sets of actions forming said activity against said one or more general rules to identify an intrusion or attempted intrusion.

2. An intrusion detection system according to claim 1, wherein said one or more general rules forms a knowledge base of the system, and wherein the system comprises means for automatically generating and storing in said knowledge base a new general rule representative of characteristics associated with specific instances of intrusion or attempted intrusion not previously taken into account.

3. An intrusion detection system according to claim 2, wherein said means for automatically generating and storing a new general rule comprises inductive logic programming means.

4. An intrusion detection system according to claim 3, wherein said one or more general rules is or are represented in a logic programming language.

5. An intrusion detection system according to claim 3, wherein inductive logic programming techniques are applied by the system to an attack an intrusion or attempted intrusion.

6. An intrusion detection system for detection of intrusion or attempted intrusion by an unauthorised party or entity to a computer system or network, the intrusion detection system comprising means for monitoring activity relative to said computer system or network, means for initially receiving and storing a knowledge base comprising one or more general rules, each of said general rules being representative of characteristics associated with a plurality of specific instances of intrusion or attempted intrusion, and means for automatically generating and storing in said knowledge base (after said knowledge base has been initially stored) new general rules representative of characteristics associated with specific instances of intrusion or attempted intrusion not previously taken into account.

7. An intrusion detection system for detection of intrusion or attempted intrusion by an unauthorised party or entity to a computer system or network, the intrusion detection system comprising means for monitoring activity relative to said computer system or network, means for initially receiving and storing in a knowledge base data representative of characteristics associated with one or more specific instances or classes of intrusion or attempted intrusion, matching means for receiving data relating to activity relative to said computer system or network from said monitoring means and for comparing sets of actions forming said activity against said stored data to identify an intrusion or attempted intrusion, and inductive logic programming means for updating said stored data to take into account characteristics of further instances or classes of intrusion or attempted intrusion occurring after said knowledge base has been initially received and stored.

8. (canceled)

9. An intrusion detection system according to claim 1, wherein said one or more general rules is or are represented in a logic programming language.

10. An intrusion detection system according to claim 2, wherein said one or more general rules is or are represented in a logic programming language.
